(19) United States
(12) Patent Application Publication
(10) Pub. No.: US 2023/0168648 A1
(43) Pub. Date: Jun. 1, 2023

(54) ENVIROMENTAL PARAMETER DETERMINATION BASED ON INDOOR AIR QUALITY

(71) Applicant: Airsset Technologies Inc., Vancouver (CA)

(72) Inventors: Marina Timmins, Vancouver (CA); Matthew Canavan, Vancouver (CA); Michael Driedger, Vancouver (CA); Andy White, Vancouver (CA); Marcos Moreno, Vancouver (CA); Vladimir Proskurin, Vancouver (CA)

(73) Assignee: Airsset Technologies Inc., Vancouver (CA)

(21) Appl. No.: 17/537,164

(22) Filed: Nov. 29, 2021

(51) Int. Cl. G05B 19/042

(52) U.S. Cl. CPC G05B 19/042; G05B 2219/2614

(57) ABSTRACT

Systems and methods of environmental parameter determination are provided. A system can include a data processing system to obtain sensor data, apply a data normalization operation to the sensor data to generate a normalized data set for storage in a database, apply at least one filter to the normalized data set to generate a filtered data set, obtain the filtered data set to generate a plurality of performance indices, generate a digital output that corresponds to the performance indices, and provide the digital output to a client computing device for display by the client computing device.

### BACKGROUND

Environmental parameters can be measured with respect to spaces, such as indoor spaces in buildings. These parameters can affect the performance of occupants present in the spaces.

### SUMMARY

At least one aspect is directed to a system of environmental parameter determination in an indoor environment. The system can include a data processing system that includes memory and at least one processor to obtain, via a network and from a plurality of sensors, indoor air composition data that indicates a plurality of metrics of at least one indoor space; apply a data normalization operation to at least a subset of the indoor air composition data to generate a normalized data set for storage in a database, the normalized data set including the indoor air composition data; apply at least one filter to the normalized data set to generate a filtered data set, the at least one filter comprising at least a time filter specific to the at least one indoor space; obtain, from the database, the filtered data set to generate a plurality of performance indices, each performance index corresponding to a respective metric of the plurality of metrics; generate, responsive to the plurality of performance indices, a digital output that corresponds to the plurality of performance indices; and provide, from the data processing system, the digital output to a client computing device for display by the client computing device.

At least one aspect is directed to a method of environmental parameter determination in an indoor environment. The method can include receiving, by a data processing system that includes memory and at least one processor, via a network and from a plurality of sensors, indoor air composition data that indicates a plurality of metrics of at least one indoor space; applying, by the data processing system, a data normalization operation to at least a subset of the indoor air composition data to generate a normalized data set for storage in a database, the normalized data set including the indoor air composition data; applying, by the data processing system, at least one filter to the normalized data set to generate a filtered data set, the at least one filter comprising at least a time filter specific to the at least one indoor space; obtain, by the data processing system from the database, the filtered data set to generate a plurality of performance indices, each performance index corresponding to a respective metric of the plurality of metrics; generating, by the data processing system responsive to the plurality of performance indices, a digital output that corresponds to the plurality of performance indices; and providing, from the data processing system, the digital output to a client computing device for display by the client computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system to perform environmental parameter determination, in accordance with an implementation.

FIG. 2 depicts an example digital output of performance indices, in accordance with an implementation.

FIG. 3 depicts an example method of environmental parameter determination, in accordance with an implementation.

FIG. 4 depicts an example computing system, in accordance with an implementation.

### DETAILED DESCRIPTION

Following below are more detailed descriptions of various concepts related to, and implementations of, methods, apparatuses, and systems of environmental parameter determination in an indoor environment. The various concepts introduced above and discussed in greater detail below may be implemented in any of numerous ways.

Various kinds of sensors can be arranged in and around indoor spaces to detect sensor data regarding the environment in the indoor spaces. For example, temperature sensors, carbon dioxide (CO₂) sensors, and volatile organic compound (VOC) sensors can be positioned in and around indoor spaces to respectively measure and output data regarding temperature, CO₂, and VOCs, respectively. The sensor data can be received directly from the sensors, or via one or more devices or networks connected with the devices.

The sensor data can be received from the sensors in a raw format, such as a raw data stream or .csv file. For example, sensor data can be received from many sensors associated with many indoor spaces in such formats, and may be asynchronous or otherwise received at different rates. As such, the sensor data can be complex and large in size, can have missing values for particular points in time, and can require significant computational processing power or storage to maintain and perform computational operations on. Further, it can be difficult to aggregate or otherwise perform operations on the sensor data in a manner that retains or provides the most useful or relevant information in a concise format while also addressing processing usage considerations. Moreover, the real-time sensor data itself can be too large and complex to evaluate without being modified in a useful manner.

Systems and methods as described herein can enable performance indices (e.g., key performance indicators) to be generated from the sensor data more efficiently and concisely, improving the information presented while reducing computational processing power or storage requirements to generate, render, and present the performance indices. For example, one or more predetermined rules, filters, or other operations can be performed on the sensor data to select targeted sensor data. The operations can include, for example, operations to select or filter for sensor data during particular periods of time or indoor spaces. The selection can be performed based on predetermined criteria indicating the particular periods of time or indoor spaces, real-time data associated with occupant actions such as entry/exit data received from access control devices, or monitoring of the sensor data itself, such as detecting changes in lighting, temperature, or air flow indicative of occupant entry or exit from indoor spaces. As such, computational demand to generate the performance indices can be reduced due to the reduced amount of sensor data to be processed to generate the performance indices, while the relevance or other criteria of the usefulness of the performance indices can be increased. At least a subset of the performance indices can be generated to be on a same scale as each other (e.g., 0-1 scale; 0-100 scale), allowing for comparison, aggregation, or other computations to be performed on the performance indices independent of the type of underlying sensor data used to generate the performance indices.

A digital output can be generated for rendering and presenting at least a subset of the performance indices. Generating the digital output can include comparing the values of the performance indices with predetermined thresholds, ranges, or other criteria, and assigning a visual indicator (e.g., color, font, text size, or other visual indicator) to the performance indices responsive to the comparison. For example, responsive to a particular performance index satisfying a threshold corresponding to sufficient occupant performance, the performance index can be assigned a green color or background as a visual indicator. This can enable additional dimensions of data to be presented with the values of the performance indices without increasing the display size or other complexities of rendering the digital output. The digital output can be provided as a template for a report that includes recommendations for actions to perform responsive to the performance indices.

The performance indices can be used to indicate or trigger various actions to improve systems associated with the indoor spaces, such as to indicate building parameter modifications. For example, heating, ventilation, and cooling (HVAC) systems may be operated in a manner that heats, ventilates, or cools spaces without actually improving occupant performance. The performance indices can be provided so that the HVAC systems can be turned on or off, cycled through operational cycles, or have their setpoints determined in a manner that more accurately promotes occupant performance. This can enable power usage to be decreased, for example via an automated or manual process.

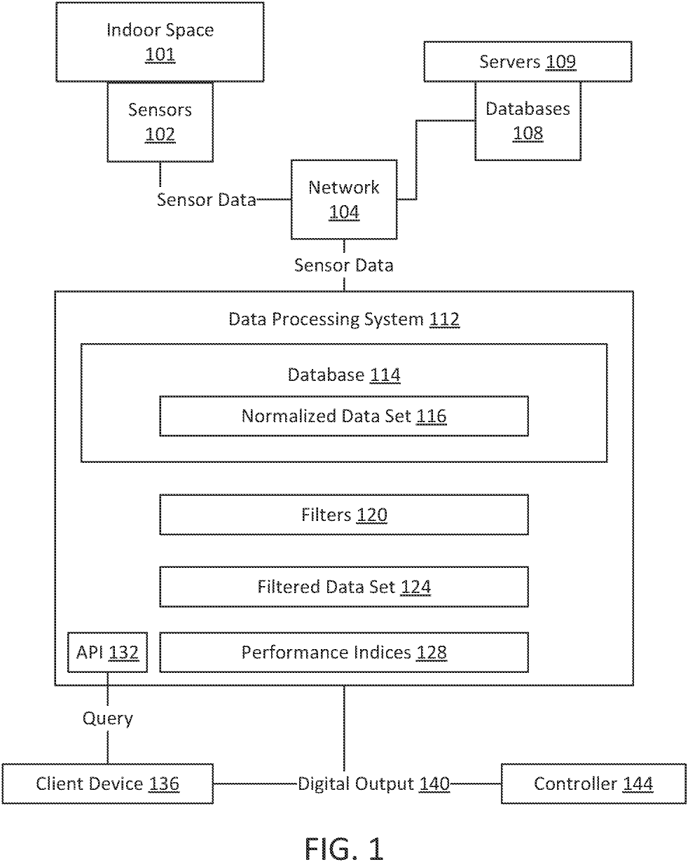

FIG. 1 depicts an example system 100 to perform environmental parameter determination in an indoor environment. The system 100 can include a plurality of sensors 102, which can transmit sensor data via at least one network 104 to any of a variety of databases 108 and data processing systems 112.

The sensors 102 can be arranged in or around at least one indoor space 101. The indoor space 101 can be a space in a building or other structure. The indoor space 101 can be at least partially enclosed, such as by being defined by one or more walls, ceilings, floors, windows, or other structural features. The indoor space 101 can have various components of heating, ventilation, or cooling (HVAC) systems connected with the indoor space, which can be used to flow air into or out of the indoor space 101, heat the air of the indoor space 101, or cool the air of the indoor space 101. Each indoor space 101 of a plurality of indoor spaces 101 can include one or more sensors 102 arranged in or around each indoor space 101, such that various sensor data can be received for each indoor space 101.

The sensors 102 can include any of a variety of sensors to detect sensor data, such as indoor air composition data, regarding environmental parameters associated with the indoor space 101, including parameters relating to the air in the indoor space 101 and air quality of the air in the indoor space 101. The sensors 102 can detect the sensor data on various schedules. For example, the sensors 102 can detect sensor data periodically; in response to a request from a remote device; during predetermined periods of time (e.g., specific hours or other periods of time during the day, week, or year); in response to trigger conditions (e.g., particular thresholds of the environmental parameters, detecting an occupant entering or exiting the indoor space 101 or being present in the indoor space for a particular period of time); or various other schedules or conditions. Various sensors 102 can detect sensor data on differing schedules or conditions.

The sensors 102 can output the sensor data as one or more sensor data points. Each sensor data point can include a value of the environmental parameter detected by the sensor 102. The sensor data point can include one more identifiers associated with the value. For example, the sensors 102 can assign identifiers to the value, such as a time stamp at which the value was detected, an identifier of the sensor 102 that detected the sensor data, a data type of the sensor data (e.g., the type of parameter, such as temperature, CO₂, or VOC data, or a unit of the parameter, such as Fahrenheit or parts per million (ppm)).

The sensors 102 can output the sensor data synchronously or asynchronously with respect to detecting the sensor data. For example, the sensors 102 can output each sensor data point as it is detected, or output the sensor data points in batches of multiple sensor data points. The sensors 102 can include various wired or wireless communications electronics to facilitate outputting the sensor data.

The sensors 102 can include various sensors for detecting air composition data or occupant presence or movement data, such as particulate sensors, light sensors, pressure sensors, motion sensors, or other sensors that can detect data regarding the air or occupancy in the indoor space. The sensors 102 can include, for example, chemical sensors, biological sensors, virus sensors, temperature sensors, humidity sensors, CO₂ sensors, VOC (e.g., total VOC) sensors, particulate matter sensors (e.g., particulate matter sensors for specific particular matter sizes, including but not limited to 1 µm (PM1), 2.5 µm (PM2.5), 4 µm (PM4), and 10 µm (PM10)), pressure sensors, carbon monoxide (CO) sensors, nitrogen dioxide (NO₂) sensors, and ozone sensors.

As such, the sensor data can indicate various metrics regarding the indoor space 101, including metrics regarding indoor air composition data of air in the indoor space 101. For example, the metrics can include metrics for viruses, temperature, humidity, CO₂, VOCs, particulate matter, pressure, CO, NO₂, and ozone. Various other metrics may also be indicated by the sensor data for various other parameters regarding the indoor space 101, such as metrics for light levels, motion, or occupant detection.

The sensor data can be transmitted using the at least one network 104. The network 104 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 104 may include a wireless link, such as an infrared channel or satellite band. The topology of the network 104 may include a bus, star, or ring network topology. The network 104 may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The sensor data can be received by at least one database 108. The database 108 can be implemented by one or more servers 109, which can incorporate features of data processing system 112, computing system 400, or various combinations thereof, as described further herein. The database 108 can be associated with an entity that manages one or more of the sensors 102, the data processing system 112, or various combinations thereof. For example, the database 108 can be associated with a first entity that manages one or more of the sensors 102, such as a manufacturer of the one or more sensors 102, and the data processing system 112 can be managed by a second entity. Each sensor 102 (or type of sensor 102) can be associated with a respective database 108. The database 108 (e.g., one or more servers 109 that implement the database 108) can perform various data cleaning, normalization, or standardization operations on the sensor data.

The data processing system 112 can include at least one logic device such as a computing device having a processor to communicate via the network 104, for example with the sensors 102 or the database 108. The data processing system 112 can include at least one computation resource, server, processor or memory. For example, the data processing system 112 can include a plurality of computation resources or servers located in at least one data center. The data processing system 112 can include multiple, logically-grouped servers and facilitate distributed computing techniques. The logical group of servers may be referred to as a data center, server farm or a machine farm. The servers can also be geographically dispersed. A data center or machine farm may be administered as a single entity, or the machine farm can include a plurality of machine farms. The servers within each machine farm can be heterogeneous - one or more of the servers or machines can operate according to one or more type of operating system platform.

Servers in the machine farm can be stored in high-density rack systems, along with associated storage systems, and located in an enterprise data center. For example, consolidating the servers in this way may improve system manageability, data security, the physical security of the system, and system performance by locating servers and high performance storage systems on localized high performance networks. Centralization of all or some of the data processing system 112 components, including servers and storage systems, and coupling them with advanced system management tools allows more efficient use of server resources, which saves power and processing requirements and reduces bandwidth usage.

The data processing system 112 can obtain the sensor data (e.g., indoor air composition data) via the network 104. For example, the data processing system 112 can transmit a request for the sensor data (or particular subsets of the sensor data) to the database 108 via the network 104 according to various predetermined schedules, or responsive to receiving a request for the sensor data. As an example, the data processing system 112 can transmit a request for (and in turn receive) the sensor data each minute. The data processing system 112 can obtain the sensor data from the sensors 102 via the network 104 (e.g., without relying on the database 108 as an intermediary connection for receiving the sensor data), including by transmitting requests to respective sensors 102 or having the sensor data pushed from the sensors 102. The data processing system 112 can receive sensor data for each of a variety of metrics simultaneously, not simultaneously (e.g., according to different schedules), periodically, or various combinations thereof at various points in time.

The data processing system 112 can obtain sensor data indicative of one or more particular metrics. For example, the data processing system 112 can obtain, via the network 104, at least one of first indoor air composition data indicative of a first metric (e.g., temperature), second indoor air composition data indicative of a second metric (e.g., VOCs), and third indoor air composition data indicative of a third metric (e.g., CO₂). The data processing system 112 can obtain indoor air composition data associated with one or more specific indoor spaces 101, such as by using one or more identifiers of the one or more indoor spaces 101 to identify respective sensors 102 associated with the one or more indoor spaces 101, and requesting the sensor data from the identified respective sensors 102.

The data processing system 112 can store the sensor data in a database 114. The database 114 can incorporate features of the database 108. The database 114 can be one or more of the databases 108. Storing the data can include, for example, performing an extra-transform-load process, in which the data is extracted by being obtained via the network 104, transformed by having data normalization operations performed, and then loaded into the database 114.

The data processing system 112 can store (e.g., load) the sensor data in the database 114 as a normalized data set 116. For example, the data processing system 112 can perform various data normalization (e.g., cleaning, standardization) operations on the sensor data. By performing data normalization on the sensor data in the database 114 to generate the normalized data set 116, the data processing system 112 can more efficiently and accurately generate performance indices based on the normalized data set 116, such as by reducing the number of computational operations needed to generate the performance indices.

The data normalization can include various operations to standardize the values of the sensor data or unit labels associated with the sensor data, such as to transform the sensor data into a predetermined format based on the type of sensor data. The type of the sensor data can indicate the environmental parameter or metric that the sensor data indicates. For example, sensor data for temperature can have a temperature type. The data processing system 112 can identify the type of the sensor data (e.g., based on an identifier indicating the source or sensor 102 of the sensor data, or by parsing the unit label provided with the sensor data), and modify the format of the sensor data to have a predetermined format for the normalized data set 116. For example, temperature data may be received having a “TMP” unit label, which the data processing system 112 can modify to “TEMP.” Temperature data can be received in one unit (e.g., Celsius), which the data processing system 112 can modify to another unit (e.g., Fahrenheit). The normalized data set 116 can be arranged with rows corresponding to time stamps and columns corresponding to the sensor data values and the unit labels corresponding to the sensor data values, along with various other data that may be received with or associated with the sensor data, such as identifiers of sensors 102 or the indoor space 101 associated with the sensors 102 or sensor data. For example, a first subset of the normalized data set 116 can correspond to a first indoor space 101, and a second subset of the normalized data set 116 can correspond to a second indoor space 101. Each subset can be identified and retrieved based on an identifier of the subset (which can correspond to an identifier of the respective indoor space 101). The data normalization operations can include sorting the sensor data based on time stamps of the sensor data, which can make downstream operations such as filters 120 more efficient.

The data normalization that the data processing system 112 performs can include identifying missing values and modifying missing values according to one or more predetermined rules. Missing values can occur, for example, where various sensors 102 provide sensor data in accordance with differing schedules, such that the sensor data from a first sensor 102 may be provided for a particular point in time, but not from a second sensor 102, or where particular sensors 102 may be offline or may output erroneous data at particular points in time. The data processing system 112 can identify a missing value and assign a null value to the value in the normalized data set 116 corresponding to the missing value. By assigning null values to missing values, the data processing system 112 can enable more accurate and rapid determination of performance indices.

The data processing system 112 can apply one or more filters 120 to the normalized data set 116 or a subset thereof to generate at least one filtered data set 124. By filtering the normalized data set 116, the data processing system 112 can reduce computational processing or storage or power usage requirements for generating performance indices 128, such as by reducing the number of data points on which to perform computer operations for generating the performance indices 128. The one or more filters 120 can be applied to selectively include data from the normalized data set 116 that satisfies criteria of the one or more filters 120 in the at least one filtered data set 124, and discard or otherwise not include data from the normalized data set 116 that does not satisfy the criteria of the one or more filters 120 in the at least one filtered data set 124. The filtered data set 124 can be stored in the database 114 or separately from the database 114.

The one or more filters 120 can be applied as part of the data normalization operations, or can be applied before or after data normalization (e.g., the at least one filtered data set 124 can be part of the or can be the normalized data set 116). The one or more filters 120 can be applied responsive to a request for performance indices 128, or can be applied on a schedule or other periodic basis.

At least a subset of the one or more filters 120 can be applied to data from the normalized data set 116 that is specific to a particular indoor space 101. This can allow the data processing system 112 to generate performance indices 128 in a manner that is more responsive to specific features of different indoor spaces 101, such as occupancy timings or occupancy rates, different ventilation patterns, or various other factors that cause each indoor space 101 to have varying air composition and effects on performance due to air composition. For example, the data processing system 112 can identify an identifier of the particular indoor space 101, and select at least one filter 120 responsive to the identifier (e.g., using a lookup table or other mapping of filters 120 to indoor spaces 101).

The one or more filters 120 can include at least one time filter. The time filter (e.g., time-based filter) can be used to select data from the normalized data set 116 that is or was detected during particular periods of time. For example, the data processing system 112 can apply the time filter by selecting at least a first time and a second time of a period, assigning indoor air composition data detected between the first time and the second time to the filtered data set, and not assigning indoor air composition data not detected between the first time and the second time to the filtered data set, the period associated with at least one of an hour, a day, a week, or a month. For example, the time filter can have at least one of a start time criteria and a stop time criteria, in order to select data that is between the start time criteria and the stop time criteria. For example, applying the time filter can include comparing a time stamp of each data point of the normalized data set 116 (or of at least a subset of the normalized data set 116 corresponding to one or more indoor spaces 101 for which the time filter is to be applied) to the start time criteria and the stop time criteria, and including in the filtered data set 124 the data point(s) that are between the start time criteria and the stop time criteria.

The time filter can be based on specific times of day, week, month, or year. For example, the period having the start time criteria and stop time criteria can be a period of a day, such as a period associated with a work day where the indoor space 101 is of an office building, or a period associated with a school day where the indoor space 101 is of a school building. The time filter can select data points from the normalized data set 116 that fall within the period (e.g., work day or school day), and discard or otherwise not use data points that are outside the period. The time filter can include data points for the period for each of a plurality of days, such as each working day of a week, month, or year. For example, the time filter can retrieve from a schedule or calendar a list of days for which to include data from the normalized data set, and filter the data points for each day of the list of days.

The data processing system 112 can apply the one or more filters 120 responsive to dynamic criteria. For example, the data processing system 112 can monitor at least a subset of the sensor data to identify conditions associated with usage of the indoor space 101, such as motion, light changes, occupancy, or other indicators of usage of the indoor space 101. For example, the data processing system 112 can retrieve access data from an access controller associated with the indoor space 101, and apply the one or more filters 120 to select sensor data having time stamps between a first time at which the access data indicates at least a threshold amount of occupancy of the indoor space 101 and a second time at which the access data indicates less than the threshold amount of occupancy, such as to select data associated with times during which at least one person is in the indoor space 101. This can enable the data processing system 112 to more accurately generate performance indices 128 from the filtered data set 124.

The data processing system 112 can apply the one or more filters 120 to discard sensor data that may have outliers errors. For example, the data processing system 112 can compare the sensor data for a particular metric with at least one of a minimum threshold associated with the particular metric and a maximum threshold associated with the particular metric, and select for the filtered data set 124 the sensor data that satisfies the at least one of the minimum threshold and the maximum threshold. Depending on the type of the sensor data, the filter 120 can be applied by applying both the minimum and maximum thresholds.

The data processing system 112 can generate one or more performances indices 128, such as for specific indoor spaces 101 and specific metrics, from the data of at least one of the normalized data set 116 or the filtered data set 124. The performance indices 128 can be concise, readily comparable or evaluatable indicators of key performance indicators or key performance metrics associated with the air composition of air in the indoor spaces 101.

For example, the performance index 128 can be a portion of time that the sensor data for a particular metric meets one or more criteria for the particular metric. The data processing system 112 can generate the performance index 128 as a fraction, percentage, ratio, or other value representing the amount of time that the sensor data meets the one or more criteria relative to a total amount of time of the period of time for which the sensor data is evaluated. For example, the data processing system 112 can determine the performance index 128 to be how much time from each day of a week, month or year that the sensor data meets the one or more criteria. The criteria can be, for example, one or more tolerances for the particular type of metric, such as minimum or maximum thresholds (which may be distinct from the thresholds or criteria used to generate the filtered data set 124).

For example, the data processing system 112 can compare each data point of the sensor data (e.g., from the filtered data set 124) to at least one of a minimum threshold or a maximum threshold, and identify each data point that satisfies the at least one of the minimum threshold or the maximum threshold. Responsive to identifying the data point(s) that satisfy the at least one of the minimum threshold or the maximum threshold, the data processing system 112 can determine an amount of time associated with the identified data point(s) and compare the amount of time with a total amount of time for the sensor data to generate the performance index 128. As an example, sensor data for particular matter metrics (e.g., PM1, PM2.5) can have maximum thresholds, and the data processing system 112 can generate the performance indices 128 for each particulate matter metric to be a portion of time that the sensor data has values less than (or less than or equal to) the maximum threshold for the respective particular matter metric.

For example, sensor data may be received for a total of 176 working hours in the month of October. The data processing system 112 can generate the performance metric 128 to have a value of 1.00 to represent all 176 working hours for the month being within the pre-set limits for the corresponding metric (e.g., for PM2.5). Responsive to determining that 48.8 working hours across the month had values that exceeded the respective threshold, such as a pre-set PM2.5 limit (48.8/176 = 0.277), the data processing system 112 can generate the performance metric 128 for PM2.5 to be 1.00 - 0.277 = 0.723, indicating that the PM2.5 levels were below the pre-set limit (threshold) of 12 µg/m³ for 72% of the total working hours measured in October. For at least some performance metrics 128, the data processing system 112 can take into account the hours where the values of the sensor data did not satisfy respective thresholds, such as by being above the maximum or below the minimum pre-set limits (e.g., for temperature and relative humidity), because there can be adverse effects associated for example with low temperatures and low relative humidity. For at least some performance metrics 128, the data processing system 112 can only take into account the hours where the sensor data was above the maximum pre-set limit (e.g., for CO₂, VOC, and PM2.5), which can reduce computational demand for generating the performance metrics 128. With respect to the performance index 128 for virus data, the data processing system 112 can generate the virus index based on at least one of minimum, maximum, and average performance index values recorded during working hours by each sensor 102 in the period (e.g., month).

The data processing system 112 can perform a weighting operation (e.g., weighted average) to generate the performance indices 128. For example, the data processing system 112 can assign priorities or weights to particular data points of the sensor data, such as when summing the number of data points meeting the thresholds or other criteria for particular metrics to determine the portion of time that the sensor data meets the criteria for the particular metrics. As an example, the data processing system 112 can assign relatively higher weights to data points associated with greater occupancy of the indoor space 101 (e.g., which the data processing system 112 can determine by monitoring occupancy associated with particular points in time).

The data processing system 112 can generate at least one performance index 128 for at least one indoor space 101. The data processing system 112 can generate multiple performance indices 128 for the at least one indoor space 101. The data processing system 112 can generate multiple performance indices 128 for multiple indoor spaces 101, such as to generate aggregate (e.g., average) performance indices 128 for a plurality of indoor spaces 101 based on the performance indices 128 for each indoor space 101 of the plurality of indoor spaces 101. The data processing system 112 can generate comparisons of performance indices 128 between indoor spaces 101, such as to compare a performance index 128 for a first indoor space 101 with a temperature performance index 128 for a second indoor space 101. The data processing system 112 can generate various measures associated with performance indices 128, such as time-averaged or median performance indices 128 over a period of time, or rates of change of performance indices 128. The data processing system 112 can generate rolling averages of performance indices 128 (e.g., 90 day rolling average). For example, the data processing system 112 can generate an aggregate performance index 128 across a plurality of performance indices 128, which can be weighted (e.g., based on user input indicative of higher priority performance indices 128).

The data processing system 112 can generate performance indices 128 (or one or more of the performance indices 128) responsive to any of a variety of trigger conditions. For example, the data processing system 112 can receive a request from a user (e.g., via a client device, which can include features of or at be at least partially implemented by the data processing system 112, the computing system 400, or various combinations thereof) for one or more performance indices 128, and generate the performance indices 128 responsive to the request. The request can include, for example, an identifier of one or more indoor spaces 101 or one or more performance indices 128 for the one or more indoor spaces 101. The trigger conditions can include a predetermined schedule for generating the performance indices 128 being satisfied; for example, the data processing system 112 can generate the performance indices 128 periodically, such as every day, week, month, quarter (e.g., three months), or year. The trigger conditions can include timings associated with usage of the indoor space 101; for example, where the indoor space 101 is of an office building, the data processing system 112 can generate the performance indices 128 at the start of a typical workday usage period (e.g., at 8AM) and end of the workday typical usage period (e.g., 6PM).

The data processing system 112 can receive sensor data from sensors 102 that monitor occupancy of particular indoor spaces 101, such as motion sensors, proximity sensors, or access controller (e.g., card or badge readers), and generate the performance indices 128 responsive to an occupancy trigger condition, such as sensor data indicating an occupant entering (or being present in) the indoor space 101, a threshold number of occupants entering (or being present in) the indoor space 101, an occupant exiting the indoor space 101, or a threshold number of occupants exiting the indoor space 101.

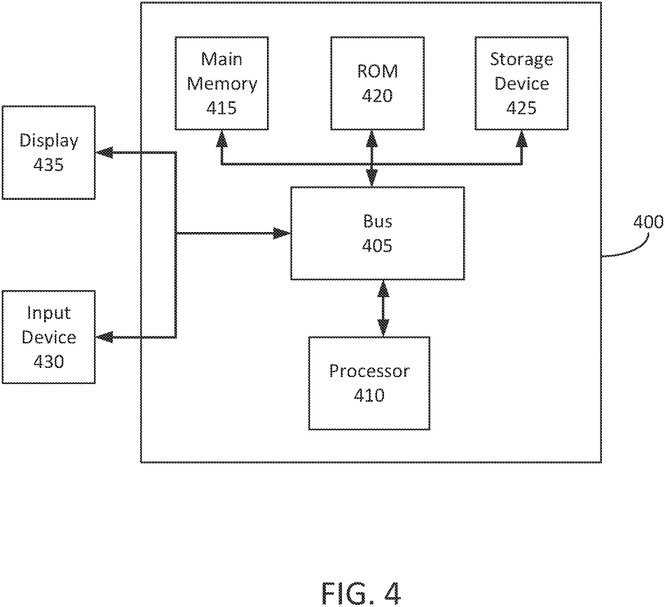

The data processing system 112 can include an application programming interface (API) 132 to receive one or more queries to generate the performance indices 128. For example, the data processing system 112 can expose access to various functions or operations of the data processing system 112 used to generate performance indices 128 using the API 132. The API 132 can receive, in the query, data from a client device 136 (e.g., computing device 400 described with reference to FIG. 4) analogous to the sensor data received from sensors 102. The API 132 can provide the received data to the data processing system 112 to cause the data processing system 112 to perform at least one of data normalization, filtering, and performance index generation on the received data to generate the performance indices 128 to provide to the client device 136. The client device 136 can be associated with various entities, such as an owner or manager of the indoor space(s) 101 for which the sensor data is detected; this can enable to the entities to have greater control over the sensor data. The API 132 can evaluate the sensor data received in the query to identify missing or incorrect values (e.g., values outside of minimum or maximum thresholds indicative of outliers), and provide a response to the client device 136 indicating the errors or requesting updated data. The API 132 can determine, from at least one of a type of the sensor data and an indication included in the query, the types of performance metrics 128 to generate (e.g., identify that temperature-based metric should be generated). The API 132 can provide the performance metrics 128 to the client device 136 that transmitted the query as a data object, such as a JSON object, or .pdf file.

The data processing system 112 can generate, responsive to the performance metrics 128, a digital output 140 that corresponds to the performance metrics 128. The digital output 140 can include at least one of a percentage, fraction, or normalized value representing the performance indices 128. The data processing system 112 can provide the digital output 140 for rendering by a display of the client device 136. The data processing system 112 can generate and provide the digital output 140 responsive to a request for the digital output 140, such as a request received from the client device 136 (e.g., from a user interface presented by the client device 136). The client device 136 can use the digital output to render and present one or more display images that include the digital output 140, such as to render a .pdf file that includes the digital output 140.

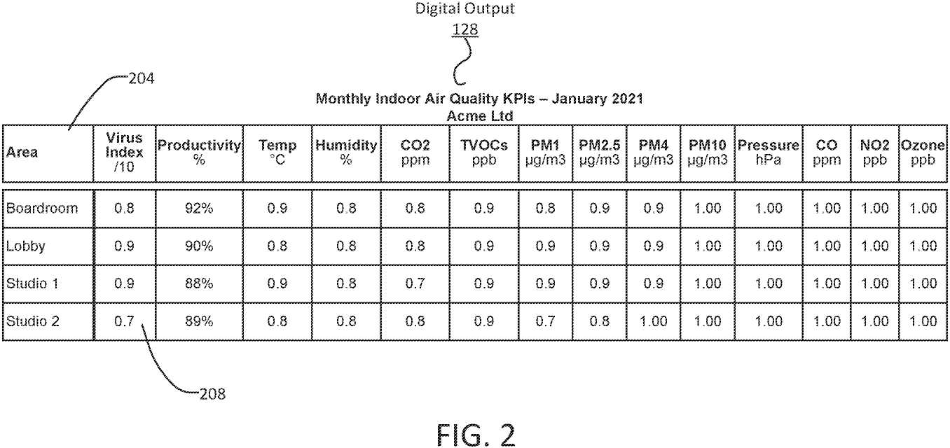

For example, as depicted in FIG. 2, the data processing system 112 can generate the digital output 140 to include at least one column 204 and at least one row 208. Each row 208 can be associated with a respective indoor space 101. Each column 204 can be associated with the performance indices 128 the corresponding indoor space 101. For example, the columns 204 can include sensor data such as virus, productivity, temperature, humidity, CO₂, VOCs, PM1, PM2.5, PM4, PM10, pressure, CO, NO₂, and ozone performance indices 128.

The digital output 140 can be generated as a template of a report providing the performance metrics 128. For example, the digital output 140 can include at least one field associated with a corresponding metric 128, such as a field to provide temperature-related information regarding a temperature metric 128. The client device 136 or data processing system 112 can receive user input (e.g., via a user interface of client device 136) to include in or update the digital output 140. The data processing system 112 can maintain a data set of a plurality of predefined text data to associate to respective fields of the digital output 140. The predefined text data can be associated with values or ranges of values of performance metrics 128. For example, VOC metric values in a first range can be associated with a first predefined text data (e.g., “VOCs were all in control with respect to their limits for the analysis period -well done!”) and in a second range can be associated with a second predefined text data (e.g., “VOCs were outside of limits for the analysis period”). The data processing system 112 can compare the values of the performance metrics 128 with corresponding values or ranges of values associated with the predefined text data to retrieve the associated predefined text data to include in the digital output 140. The data processing system 112 can combine predefined text data regarding multiple performance metrics 128 to dynamically generate more concise text data, which can reduce processing power for rendering the digital output 140 as well as display size required for the digital output 140. For example, responsive to determining that each of a first performance metric 128 and a second performance metric 128 satisfy respective values or ranges of values for being within corresponding thresholds, the data processing system 112 can generate a single text string data providing this information for both of the first and second performance metrics 128 (e.g., “VOCs and PM2.5 were all in control with respect to their limits for the analysis period - well done!”, as compared to two distinct text strings for both the VOC performance metric 128 and the PM2.5 performance metric).

The data processing system 112 can compare the values of the performance indices 128 to respective thresholds, and adjust how the data is displayed by assigning at least one visual indicator to the performance indices 128 responsive to the comparisons. For example, if the performance index 128 for a particular indoor space 101 is greater than a first display threshold (e.g., greater than 80), the data processing system 112 can cause the performance index 128 to be displayed using a green color.

The data processing system 112 can provide the performance indices 128 to one or more controllers 144, such as to cause the controllers 144 to reduce power usage of controlled devices. The controllers 144 can be, for example, devices that control operation of HVAC devices or systems, such as controllers of heaters, air conditioners, fans, pumps, or valves, including but not limited to thermostats. The controllers 144 can be controllers of lighting systems. The controllers 144 can adjust operation of controlled devices responsive to one or more of the performance indices 128, such as to reduce power usage of the controlled devices while maintaining appropriate environmental conditions for occupant performance, such as by opening or closing vents, opening or closing valves, turning on or off pumps, or adjusting setpoints associated with operation of various devices. For example, the controller 144 for an HVAC device can store at least one setpoint responsive to which the HVAC device causes heating (or cooling), such as to activate or deactivate a fan, pump, or valve. The setpoints can be temperature-based setpoints. The controller 144 can adjust the setpoints responsive to the performance indices 128, such as to increase a setpoint for activating a cooling process responsive to the performance index 128 being greater than a performance threshold (e.g., a threshold indicative of sufficient performance levels). For example, the controller 144 can have a setpoint of 74° F., above which the controller 144 causes a cooling process to occur. Responsive to determining that the performance index 128 satisfies the performance threshold while the temperature is 74° F., the controller 144 can increase the setpoint (e.g., to 75° F.), which can avoid power usage for cooling between 74 and 75° F. without allowing performance to fall below the performance threshold.

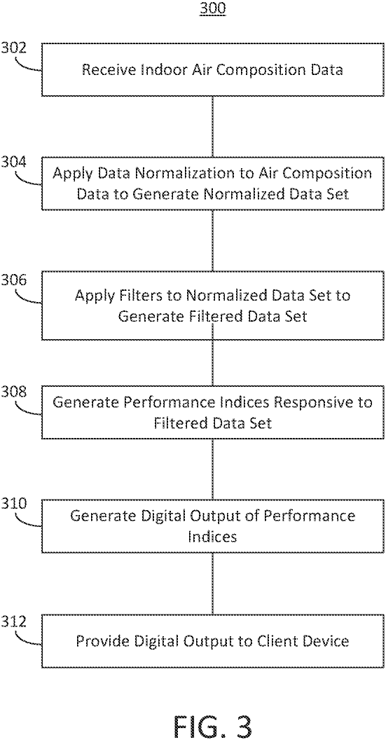

FIG. 3 depicts an example of a method 300 of environmental parameter determination. The method 300 can be performed using various systems and devices described herein, including but not limited to the system 100 and the computer system 400. The method 300 or portions or steps thereof can be performed responsive to various conditions, such as requests for performance indices, such as for generating and presenting digital outputs of performance indices, or for controlling operation of devices that rely on the performance indices.

At 302, indoor air composition data is received. The indoor air composition data can include data from a plurality of sensors, such as chemical sensors, biological sensors, virus sensors, temperature sensors, humidity sensors, CO₂ sensors, VOC sensors, particulate matter sensors, pressure sensors, CO sensors, NO₂ sensors, and ozone sensors. The indoor air composition data can be obtained via a network. The indoor air composition data can be received from the sensors via the network, from one or more databases that receive the indoor air composition data from the sensors, or various compositions thereof. The indoor air composition data can be obtained responsive to a request for indoor air composition data, such as a request for indoor air composition data for a particular indoor space or a particular plurality of indoor spaces, or responsive to the sensors or the database outputting the indoor air composition data. The indoor air composition data (or other sensor data) can be received in a query from a client device for performance indices, such as through an API. The indoor air composition data can be received responsive to a request for the indoor air composition data, such as a request indicating at least one of a particular indoor space or a particular period of time for the indoor air composition data.

At 304, data normalized is applied to the indoor air composition data to generate a normalized data set. The data normalization can be applied to standardize the indoor air composition data, such as to assign predetermined unit labels to the indoor air composition data (e.g., assign “TEMP” instead of “TMP” as a unit label for temperature data). The data normalization can include modifying units (e.g., Fahrenheit to Celsius) or a scale of the indoor air composition data (e.g., filtering out data values that are above maximum thresholds or below minimum thresholds), such as to modify the data to correspond to a predetermined numerical scale. The data normalization can include assigning null values to missing values.

At 306, at least one filter is applied to the normalized data set to generate a filtered data set. The at least one filter can select indoor air composition data to include in the filtered data set, specific to each indoor space of one or more indoor spaces, based on factors such as expected or measured occupancy times for the indoor space. For example, the at least one filter can include predetermined start times and stop times for occupancy of the indoor space, such as start times and stop times associated with a work day or school day. The at least one filter can generate the start times and stop times responsive to monitoring sensor data associated with occupancy of the indoor space, such as access data or motion data, or changes in sensor data, such as increases or decreases in temperature.

At 308, one or more performance indices are generated responsive to the filtered data set. Each performance index can correspond to a type of data of the filtered data set, such as temperature data or pressure data. The performance index can be generated as a fraction or other portion of time relative to a total measurement period during which the corresponding indoor air composition data satisfies one or more criteria specific to the type of data, such as one or more of minimum or maximum tolerances. For example, the number of working hours in a month during which the indoor air composition data is less than a maximum threshold for a particular metric (e.g., PM2.5) can be compared with the total number of working hours in the month to generate the performance index, such as to generate the performance index as the ratio of the two values. The performance index for each type of indoor air composition data can be generated on a same scale, such as a 0-1 or 0-100 (e.g., percentage scale). Multiple performance indices can be aggregated, such as through averaging, to improve the conciseness of presentation of the performance indices.

At 310, a digital output of the performance indices is generated. The digital output can include the values of each performance indices, which can be mapped to particular indoor spaces for which the performance indices were generated. The digital output can include a table, chart, or other graphic representing the performance indices. For example, the digital output can include a table having rows corresponding to respective indoor spaces and columns corresponding to values of performance indices. The digital output can be provided using a JSON object (e.g., via the API), a .pdf file, or a webpage.

At 312, the digital output is provided to a client device. For example, the digital output can be provided to a client device that requested the digital output. The digital output can be provided via a network connection between one or more devices that generated the performance indices and the client device.

FIG. 4 is a block diagram of an example computer system 400. The computer system or computing device 400 can include or be used to implement the system 100, or its components such as the data processing system 112. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. The main memory 415 can be or include the database 114. The main memory 415 can also be used for storing position information, temporary variables, or other intermediate information during execution of instructions by the processor 410. The computing system 400 may further include a read only memory (ROM) 420 or other static storage device coupled to the bus 405 for storing static information and instructions for the processor 410. A storage device 425, such as a solid state device, magnetic disk or optical disk, can be coupled to the bus 405 to persistently store information and instructions. The storage device 425 can include or be part of the database 114.

The computing system 400 may be coupled via the bus 405 to a display 435, such as a liquid crystal display, or active matrix display, for displaying information to a user. An input device 430, such as a keyboard including alphanumeric and other keys, may be coupled to the bus 405 for communicating information and command selections to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435. The display 435 can be part of the data processing system 112, the client device 136 or other component of FIG. 1, for example.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multiprocessing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, cloud computing, distributed computing and grid computing infrastructures. For example, the database 114 and other data processing system 112 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 112) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 400 can include clients and servers. A client and server are generally remote from each other and typically interact through a communication network (e.g., the network 104). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device). Data generated at the client device (e.g., a result of the user interaction) can be received from the client device at the server (e.g., received by the data processing system 112).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the data processing system 112 can be a single component, app, or program, or a logic device having one or more processing circuits, or part of one or more servers of the data processing system 112.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, while the performance indices are described primarily in terms of being generated by the data processing system 112, the performance indices can be generated at least partially by client device 136 or in a distributed manner. The various indices can be data structures that can be organized, managed, and stored by the data processing systems and processors described herein. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system of environmental parameter determination in an indoor environment, comprising:
a data processing system comprising memory and at least one processor to:
obtain, via a network and from a plurality of sensors, indoor air composition data that indicates a plurality of metrics of at least one indoor space;
apply a data normalization operation to at least a subset of the indoor air composition data to generate a normalized data set for storage in a database, the normalized data set including the indoor air composition data;
apply at least one filter to the normalized data set to generate a filtered data set, the at least one filter comprising at least a time filter specific to the at least one indoor space;
obtain, from the database, the filtered data set to generate a plurality of performance indices, each performance index corresponding to a respective metric of the plurality of metrics;
generate, responsive to the plurality of performance indices, a digital output that corresponds to the plurality of performance indices; and
provide, from the data processing system, the digital output to a client computing device for display by the client computing device.

2. The system of claim 1, comprising:
the data processing system is to generate each performance index of the plurality of performance indices by determining a portion of time that the indoor air composition data of the filtered data set corresponding to the respective metric corresponding to the each performance index satisfies at least one of a minimum threshold or a maximum threshold for the respective metric.

3. The system of claim 1, comprising:
the data processing system is to apply the time filter by selecting at least a first time and a second time of a period, assigning indoor air composition data detected between the first time and the second time to the filtered data set, and not assigning indoor air composition data not detected between the first time and the second time to the filtered data set, the period associated with at least one of an hour, a day, a week, or a month.

4. The system of claim 1, comprising:
the data processing system is to generate the filtered data set by selecting indoor air composition data between a first time of day and a second time of day for each of a plurality of days of a period, the period associated with at least one of a week or a month.

5. The system of claim 1, comprising:
the data processing system is to generate each performance index by averaging the indoor air composition data for the respective metric of the plurality of metrics.

6. The system of claim 1, comprising:
the at least one indoor space comprises at least a first indoor space and a second indoor space; and
the data processing system is to apply the at least one filter by applying at least a first filter to indoor air composition data associated with the first indoor space and a second filter to indoor air composition data associated with the second indoor space.

7. The system of claim 1, comprising:
the data processing system is to apply the at least one filter by:
comparing the indoor air composition data for a particular metric of the plurality of metrics with each of a minimum threshold associated with the particular metric and a maximum threshold associated with the particular metric; and
including the indoor air composition data for the particular metric in the filtered data set that satisfies each of the minimum threshold and the maximum threshold.

8. The system of claim 1, comprising:
the data processing system is to generate the time filter responsive to at least one (1) of a value identified from the indoor air composition data satisfying a filter criteria or (2) detecting occupant activity in the at least one indoor space.

9. The system of claim 1, comprising:
the data processing system is to identify at least one missing value of a data point of the indoor air composition data and assign a null value to the missing value of the data point.

10. The system of claim 1, comprising:
the digital output corresponding to at least one performance index of the plurality of performance indices is a percentage value.

11. The system of claim 1, comprising:
the data processing system is to apply the data normalization operation to generate the normalized data set by modifying the indoor air composition data to correspond to a predetermined numerical scale.

12. The system of claim 1, comprising:
the data processing system is to obtain the indoor air composition data from each of the plurality of sensors at least one of simultaneously and periodically.

13. The system of claim 1, comprising:
the data processing system is to generate the plurality of performance indices by receiving, at an application programming interface (API), a query comprising the indoor air composition data and providing the plurality of performance indices responsive to the query.

14. The system of claim 1, comprising:
the data processing system is to provide at least one performance index of the plurality of performance indices to cause reduced power usage of a device associated with the indoor space responsive to the at least one performance index.

15. A method of environmental parameter determination in an indoor environment, comprising:
receiving, by a data processing system comprising memory and at least one processor, via a network and from a plurality of sensors, indoor air composition data that indicates a plurality of metrics of at least one indoor space;
applying, by the data processing system, a data normalization operation to at least a subset of the indoor air composition data to generate a normalized data set for storage in a database, the normalized data set including the indoor air composition data;
applying, by the data processing system, at least one filter to the normalized data set to generate a filtered data set, the at least one filter comprising at least a time filter specific to the at least one indoor space;
obtain, by the data processing system from the database, the filtered data set to generate a plurality of performance indices, each performance index corresponding to a respective metric of the plurality of metrics;
generating, by the data processing system responsive to the plurality of performance indices, a digital output that corresponds to the plurality of performance indices; and
providing, from the data processing system, the digital output to a client computing device for display by the client computing device.

16. The method of claim 15, comprising:
generating, by the data processing system, each performance index of the plurality of performance indices by determining a portion of time that the indoor air composition data of the filtered data set corresponding to the respective metric corresponding to the each performance index satisfies at least one of a minimum threshold or a maximum threshold for the respective metric.

17. The method of claim 15, comprising:
generate each performance index by averaging the indoor air composition data for the respective metric of the plurality of metrics.

18. The method of claim 15, the at least one indoor space comprising a first indoor space and a second indoor space, the method comprising:
applying, by the data processing system, the at least one filter by applying at least a first filter to indoor air composition data associated with the first indoor space and a second filter to indoor air composition data associated with the second indoor space.

19. The method of claim 15, comprising:
comparing the indoor air composition data for a particular metric of the plurality of metrics with each of a minimum threshold associated with the particular metric and a maximum threshold associated with the particular metric; and
including the indoor air composition data for the particular metric in the filtered data set that satisfies each of the minimum threshold and the maximum threshold.

20. The method of claim 15, comprising:
generating the plurality of performance indices by receiving, by the data processing system at an application programming interface (API), a query comprising the indoor air composition data and providing the plurality of performance indices responsive to the query.
